(19) United States
(12) Patent Application Publication
(10) Pub. No.: US 2026/0217878 A1
(43) Pub. Date: Jul. 30, 2026

(54) PROCESS FOR THE PRODUCTION OF PVC IN AQUEOUS SUSPENSION USING A MIXTURE OF INITIATORS AND AN ACTIVITY CONTROL AGENT

(71) Applicant: INOVYN EUROPE LIMITED, Runcorn, Cheshire (GB)

(72) Inventor: Thomas HERMANT, Lonzee (BE)

(21) Appl. No.: 19/141,527

(22) PCT Filed: Dec. 12, 2023
(86) PCT No.: PCT/EP2023/085334

§ 371 Date: Jun. 20, 2025

(30) Foreign Application Priority Data
Dec. 20, 2022 (EP) 22215208.4

(51) Int. Cl. C08F 114/06

(52) U.S. Cl. CPC C08F 114/06

(57) ABSTRACT

Processes for the production of PVC, and in particular a process for the production of PVC by polymerisation of vinyl chloride which comprises
(a) reacting an acyl halide with a peroxide in a reactor to form a diacyl peroxide,
(b) in the same reactor, and without removing the diacyl peroxide formed in step (a), reacting an alkyl haloformate with a peroxide, to form a dialkyl peroxydicarbonate, and to produce a mixture comprising the diacyl peroxide and the dialkyl peroxydicarbonate, and
(c) using the mixture comprising the diacyl peroxide and the dialkyl peroxydicarbonate as an initiator mixture for the polymerisation of vinyl chloride.

### FIELD AND BACKGROUND OF THE INVENTION

The present invention relates to processes for the production of PVC, and in particular to processes which comprise polymerising vinyl chloride using a mixture of initiators.

Polyvinylchloride (PVC) is one of the most important thermoplastic materials on the market today. Given its very good mechanical and physical properties, it is used in a large number of applications.

Several processes are known for the preparation of PVC. For example, PVC may be prepared by suspension polymerisation of vinyl chloride in a suspending liquid and in the presence of a suspending agent. This produces a slurry (or suspension) of PVC particles, typically of the order of 100 to 200 microns particle size. The resulting slurry of PVC is then dried, usually by centrifuging followed by fluid bed drying, to give a porous (i.e. sorbent) PVC. PVC produced by the suspension method is referred to as “S-PVC”. S-PVC can absorb plasticisers to give a dry blend.

PVC can also be produced by what are generally known as paste polymerisation processes. Paste processes may be characterised in that the polymerisation produces a latex of polymer particles of relatively small size compared to the S-PVC process, typically 0.2 to 5 microns. The latex can be dried, for example by spray-drying to produce PVC particles in the form of agglomerates. The dried PVC polymer particles are typically much smaller than the dried particles produced by the suspension PVC processes.

Whether produced by suspension or paste processes, the general process for polymerisation involves polymerisation in a solvent, typically water, and the use of one or more initiators, which are typically peroxides or other compounds that decompose to provide radicals which can initiate polymerisation. Initiators may have a half-life of the order of a few seconds to several hours at the polymerisation temperature, and can be added both to start polymerisation but also during the polymerisation to provide additional polymerisation activity.

The polymerisation of vinyl chloride is an exothermic reaction and the reaction is typically kept at a desired temperature using cooling, particular cooling water in a reactor jacket. In preferred operation the reactor is operated as close as possible to the maximum cooling capacity of the reactor as this maximises reaction rate/reactivity, and therefore the production of the process. A problem generally is controlling the amount of initiators to obtain a largely stable polymerisation rate which is as close as possible to the cooling capacity available. For example, if an initiator with a relatively long half-life is used the reaction may take some time to reach desirable production rates, and there is also a time lag between addition of more initiator and when the reactivity increases. On the other hand, use of initiators with a relatively short half-life can give a quicker increase in reactivity, but the effect is not long-lasting and therefore the initiator has to be added constantly or at least regularly to maintain reactivity.

To try and overcome such issues it is known to use mixtures of initiators. EP 1618137, for example, describes a process which uses a mixture of initiators with different half-lives, with the shorter half-life initiator being dosed to the reactor over at least the initial period of the polymerisation to provide reactivity in the initial stages.

Whilst this allows some control of the reactivity, initiators with short half-lives are, by their nature, relatively unstable. Thus, such initiators are typically cooled in transport and storage and, because of this, often kept in solution involving an alcohol. This increases the chemical oxygen demand of the initiator solutions. Diisobutyryl peroxide, for example, is provided in a solution of water and alcohol and it is recommended to be stored at −20° C. When being dosed to a process over a period of time, either continuously or intermittently, the initiator may also be present in the pipes or injection system to the reactor for relatively significant periods of time at temperatures which are at ambient or well above ambient. Thus, cooling may have to be provided to the pipes or other methods taken to mitigate the risk of initiator decomposition in the pipes.

Another problem with initiator mixtures is that additives which can be used to control reactivity of one initiator may be ineffective against the other initiator. In particular, it is common to use in the process a suitable agent (“inhibitor” or “activity control agent”) which can reduce the reaction rate by terminating the reaction. Examples of known activity control agents include alkali metal halides, nitrogen monoxide and alkali metal nitrites. For example, alkali metal halides can be used to terminate and hence control reactivity of initiators such as peroxydicarbonates. However, a number of such activity control agents are ineffective when used with peroxides such as diisobutyryl peroxide.

It is still desired therefore to provide processes for the production of PVC which enable high reactivity of the process to be maintained throughout the polymerisation in a safe manner. It is also desired to simplify the provision and use of initiators in such processes.

### SUMMARY OF THE INVENTION

Thus, in a first aspect, the present provides a process for the polymerisation of PVC which comprises
a. reacting an acyl halide with a peroxide in a reactor to form a diacyl peroxide,
b. in the same reactor, and without removing the diacyl peroxide formed in step (a), reacting an alkyl haloformate with a peroxide, to form a dialkyl peroxydicarbonate, and to produce a mixture comprising the diacyl peroxide and the dialkyl peroxydicarbonate, and
c. using the mixture comprising the diacyl peroxide and the dialkyl peroxydicarbonate as an initiator mixture for the polymerisation of vinyl chloride.

A particular advantage of the process of the first aspect of the present invention is its simplicity. In particular, the mixture of initiators can be prepared just prior to being required for use, and the mixture can be used as formed. In particular, there is no need to perform any steps to purify the mixture as obtained in step (b), and no storage is required in this case.

Thus, in a preferred embodiment the mixture produced after reaction of the alkyl haloformate with the peroxide to form a dialkyl peroxydicarbonate in step (b) is used for the polymerisation of vinyl chloride in step (c) without purification and within 24 hours of the start of step (a) of the process. The mixture is preferably used within 12 hours, more preferably within 6 hours, such as within 4 hours or even within 1 hour of the start of step (a) of the process. Although not kept for long periods before use in this embodiment, preferably the mixture is kept cool, such as in the range 1° C. to 10° C. or in the range 1° C. to 5° C., until used.

In some embodiments, as described further below, the mixture produced after reaction of the alkyl haloformate with the peroxide to form a dialkyl peroxydicarbonate in step (b) may comprise an aqueous phase and an organic phase, and the organic phase may be separated from the aqueous phase to provide the mixture comprising the diacyl peroxide and the dialkyl peroxydicarbonate for use in step (c).

Whilst not generally preferred, it is also possible to prepare a mixture according to steps (a) and (b) for later use in a polymerisation according to step (c). Thus, the mixture produced after reaction of the alkyl haloformate with the peroxide to form a dialkyl peroxydicarbonate in step (b) may be removed from the reactor and stored. In such embodiments the mixture comprising the diacyl peroxide and the dialkyl peroxydicarbonate may be stored for 24 or more hours, such as 48 hours or more, before use in step (c). To enable storage for such periods the mixture should be cooled during storage, for example below 10° C., such as below 5° C. In embodiments where the mixture produced after reaction of the alkyl haloformate with the peroxide to form a dialkyl peroxydicarbonate in step (b) comprises an aqueous phase and an organic phase, it is preferred that the organic phase is separated from the aqueous phase to provide the mixture comprising the diacyl peroxide and the dialkyl peroxydicarbonate for storage (and later for subsequent use in step (c)). This allows the mixture (i.e. the organic phase) comprising the diacyl peroxide and the dialkyl peroxydicarbonate to be cooled and stored below 0° C.

The reaction of step (a) comprises reacting an acyl halide with a peroxide in a reactor to form a diacyl peroxide. The reactants may be added in any suitable order, but preferably the reaction comprises adding water, a base and a peroxide to a reactor in an initial step or steps. In preferred embodiments an organic solvent is also added at this stage. In some embodiments, particularly when an organic solvent is also used, the water may be brine i.e. water comprising sodium chloride. This increases the density of the aqueous phase and can improve the separation of the phases where this is desired.

The acyl halide is then added, at which point an exothermic reaction occurs to produce the diacyl peroxide. Typically the reactor is cooled, and in particular the reaction is maintained at a temperature below 20° C. even with the exotherm from the reaction of the acyl halide. For example, the reaction may be performed at a temperature in the range 1 to 15° C. The acyl halide can be introduced at a rate such that the exotherm does not result in a temperature exceeding 20° C., preferably not exceeding 15° C. The reaction may be performed at any suitable pressure, but most usually is performed at atmospheric pressure.

The acyl halide is preferably an acyl chloride. The suitable acyl chloride is defined by the required diacyl peroxide. For example, if diisobutyryl peroxide is desired than isobutyryl halide, preferably chloride, is used. In a preferred embodiment of this first aspect the diacyl peroxide is a diacyl peroxide where said acyl has 2 to 8 carbons atoms.

The preferred base for this step is an alkali metal hydroxide, with sodium hydroxide being preferred.

The preferred peroxide (used as reactant) is hydrogen peroxide.

Typical organic solvents which can be used include any which are not miscible with water. This allows aqueous and organic phases to be separated if desired. Suitable examples of organic solvents include alkanes, such as pentane, and diesters. Preferred organic solvents have a freezing point below 0° C., such as below- 5° C., particularly where the organic phase may be separated for storage of the mixture before step (c) of the present invention. A particularly preferred organic solvent is dioctyl adipate.

The reaction of step (b) comprises reacting an alkyl haloformate with a peroxide to form a dialkyl peroxydicarbonate. The reaction typically comprises adding additional peroxide and alkyl haloformate to the solution in the reactor from the step (a). Further base is then added, at which point an exothermic reaction occurs to produce the dialkyl peroxydicarbonate.

As with step (a) the reactor is typically cooled in this step. (And, in fact, the reactor is typically cooled throughout steps (a) and (b) of the synthesis, also between the steps and also at the end of the synthesis.) In particular, in this step, the reaction is maintained at a temperature below 20° C. even with the exotherm from the reaction of the alkyl haloformate. For example, the reaction in this step may be performed at a temperature in the range 1 to 15° C. The alkyl haloformate can be introduced at a rate such that the exotherm does not result in a temperature exceeding 20° C., preferably not exceeding 15° C.

Similarly, again the reaction may be performed at any suitable pressure, including atmospheric pressure. Usually step (b) is performed at the same pressure as step (a) and preferably the entire synthesis may be performed at the same pressure, most preferably at atmospheric pressure.

The alkyl haloformate is preferably an alkyl chloroformate. The suitable alkyl haloformate is defined by the required dialkyl peroxydicarbonate. For example, if diethyl peroxydicarbonate is desired ethyl haloformate, preferably ethyl chloroformate, is used. In a preferred embodiment of this first aspect the dialkyl peroxydicarbonate is a dialkyl peroxydicarbonate where said alkyl has 1-4 carbon atoms.

The preferred base for this step is an alkali metal hydroxide, with sodium hydroxide again being preferred.

The preferred peroxide (used as reactant) is hydrogen peroxide.

Additional water can be added in this step if required.

Sodium chloride can be added in this step, particularly if not added in the first step.

An organic solvent may be added in this step if required, particularly if not added in the first step.

In the present invention the formations of the diacyl peroxide and of the dialkyl peroxydicarbonate are performed sequentially. This has the advantage that the relative amounts of the diacyl peroxide and the dialkyl peroxydicarbonate in the formed mixture are easy to control (by use of suitable amounts of reactants in each step) and that “mixed” products can be avoided.

In relation to the first of these points, the mixture of the diacyl peroxide and the dialkyl peroxydicarbonate formed (and used) may comprise the diacyl peroxide and the dialkyl peroxydicarbonate in any suitable relative ratio. Typically the weight ratio of the diacyl peroxide and the dialkyl peroxydicarbonate is from 1:4 to 4:1, more preferably from 1:3 to 3:1, such as 1:3 to 2:1, and most preferably from 1:3 to 1:1.

In relation to the “mixed” products, in some known prior art processes mixtures of diacyl peroxides and dialkyl peroxydicarbonates are formed by reaction of acyl chlorides and alkyl chloroformates with hydrogen peroxide in a single step. This forms a mixture of a desired diacyl peroxide (with acyl based on the chloride reactant) and dialkyl peroxydicarbonate (with alkyl based on the chloroformate reactant), but also a “mixed” reaction product which is an acyl peroxycarbonate, usually in significant quantities. Processes in which dialkyl pyrocarbonate, acyl anhydride and hydrogen peroxide are reacted are also known, and again result in a peroxide and peroxydicarbonate, but also a mixed acyl peroxycarbonate. The process of the present invention, in contrast, can provide a mixture without such compounds.

In particular, the presence of the mixed product can be avoided by ensuring that the acyl halide has been fully reacted in step (a) prior to addition of the alkyl haloformate and further peroxide in step (b).

Whilst it is generally preferred that no acyl peroxycarbonate is present in the mixture obtained at the end of step (b), nevertheless a small amount of “mixed” product may be tolerated. Preferably, therefore, the composition comprises either no acyl peroxycarbonate or comprises acyl peroxycarbonate in an amount which is less than 20% by weight relative to the total weight of diacyl peroxide and dialkyl peroxydicarbonate in the mixture. More preferably the composition comprises either no acyl peroxycarbonate or comprises acyl peroxycarbonate in an amount which is less than 10% by weight, such as less than 5% by weight, relative to the total weight of diacyl peroxide and dialkyl peroxydicarbonate in the mixture.

In step (c) of the first aspect the mixture comprising the diacyl peroxide and the dialkyl peroxydicarbonate is used as an initiator mixture for the polymerisation of vinyl chloride.

The polymerisation of vinyl chloride may be performed under any suitable conditions for such a reaction, some of which are described further below. In a particularly preferred option, the polymerisation takes place in the presence of an activity control agent. Suitable activity control agents are well known in the art, but in the present invention preferably comprise an alkali metal halide, nitrogen monoxide or an alkali metal nitrite. Preferably the activity control agent is an alkali metal halide, and more preferably is an alkali metal iodide, such as sodium iodide or potassium iodide. Most preferably it is potassium iodide.

In a further preferred embodiment of this first aspect the diacyl peroxide is a diacyl peroxide where said acyl has 2 to 8 carbons atoms and the dialkyl peroxydicarbonate is a dialkyl peroxydicarbonate where said alkyl has 1-4 carbon atoms.

### BRIEF DESCRIPTION OF DRAWINGS

FIG. 1 is a graph of the percentage of available cooling capacity used versus time in Example A.

FIG. 2 is a graph of the percentage of available cooling capacity used versus time in Example B.

FIG. 3 is a graph of the percentage of available cooling capacity used versus time in Comparative Example A.

### DETAILED DESCRIPTION OF THE INVENTION

In the present invention it has been found a particularly preferred polymerisation can be obtained by use of a selected activity control agent with a defined mixture of diacyl peroxides and dialkyl peroxydicarbonates.

Thus, in a second aspect, there is provided a process for the production of PVC which comprises polymerising vinyl chloride in suspension in an aqueous medium using a mixture of initiators and using an activity control agent, where the activity control agent comprises an alkali metal halide, nitrogen monoxide or an alkali metal nitrite, and where the mixture of initiators comprises
a. a first initiator, which is a diacyl peroxide, said acyl having 2-8 carbon atoms, and
b. a second initiator, which is a dialkyl peroxydicarbonate, said alkyl having 1-4 carbon atoms.

In particular, although the defined activity control agents are not usually effective when used with the first initiator/diacyl peroxide alone it has been found that using them with a mixture of diacyl peroxides and dialkyl peroxydicarbonates as in this second aspect, where the said alkyl of the dialkyl peroxydicarbonate has 1-4 carbon atoms, the activity control agent is effective for control of the polymerisation. In particular, with this particular combination it has been found that the selected activity control agent is also effective for terminating the radicals obtained from the diacyl peroxide initiator.

In this second aspect, preferably the activity control agent is an alkali metal halide, and more preferably is an alkali metal iodide, such as sodium iodide or potassium iodide. Most preferably it is potassium iodide.

In preferred embodiments of this second aspect the mixture of initiators in the process is obtained by adding a mixture comprising the first and second initiators to the process i.e. the initiators are added together, not separately to the process.

In preferred embodiments of this second aspect the mixture comprising the initiators is added to the process solely at the start of the polymerisation. This is particularly advantageous because then all initiator mixture can be removed from feed pipes and injection means on the reactor. The pipes/injection means can, for example, be flushed with solvent, typically water, to remove any residual initiators. This provides a safe process without the need to cool the pipes or injection means.

The preferred features of the mixture of initiators (diacyl peroxide and dialkyl peroxydicarbonate) used in the process of this second aspect are generally as set out for the first aspect. For example, the mixture may comprise the diacyl peroxide and the dialkyl peroxydicarbonate in any suitable relative ratio, but preferably the weight ratio of the diacyl peroxide and the dialkyl peroxydicarbonate is from 1:4 to 4:1, more preferably from 1:3 to 3:1, such as 1:3 to 2:1, and most preferably from 1:3 to 1:1.

Similarly, it is generally preferred that no acyl peroxycarbonate is present in the mixture of initiators (or in the polymerisation more generally) but nevertheless a small amount of “mixed” product may be tolerated. Preferably, the process comprises either no acyl peroxycarbonate or comprises acyl peroxycarbonate in an amount which is less than 20% by weight relative to the total weight of diacyl peroxide and dialkyl peroxydicarbonate in the mixture. More preferably the composition comprises either no acyl peroxycarbonate or comprises acyl peroxycarbonate in an amount which is less than 10% by weight, such as less than 5% by weight, relative to the total weight of diacyl peroxide and dialkyl peroxydicarbonate in the mixture.

In the most preferred embodiments a process is operated according to both the first and second aspects of the present invention. In particular, the mixture of initiators of the second aspect is formed by the process of the first aspect.

In preferred embodiments of both the first and second aspects of the present invention the diacyl peroxide may be a diacyl peroxide where said acyl has 2-5 carbon atoms, such as 2-4 carbon atoms. A most preferred diacyl peroxide is diisobutyryl peroxide.

In preferred embodiments of both the first and second aspects of the present invention the dialkyl peroxydicarbonate may be a dialkyl peroxydicarbonate where said alkyl has 1-3 carbon atoms, and more preferably 1-2 carbon atoms. A preferred dialkyl peroxydicarbonate is diethylperoxydicarbonate.

Turning to the polymerisation process steps more generally, the polymerisation process may be performed as any suitable polymerisation process, but is preferably performed as a suspension polymerisation process. The polymerisation steps may then suitably be performed in any suitable apparatus known for suspension polymerisation processes.

Typically, the polymerisation takes place in an aqueous suspension in the presence of a suitable suspension agent. Any suitable suspension agent may be used for polymerisation, but particularly preferred suspension agents are polyvinyl acetates of various degrees of hydrolysis and water-soluble cellulosic esters. These suspension agents can be used together with secondary suspension agents if desired. The amount employed may vary widely and is generally between 0.05 and 1.5% by weight calculated on vinyl chloride used. Other additives conventionally known to be used in suspension polymerisation of vinyl chloride to produce PVC may also be present, including buffers and chain transfer agents.

One or more chain transfer agents may be used in the polymerisation process. Chain transfer agents are known for use to control molecular weight in vinyl chloride polymerisations, particularly in polymerisations performed at higher temperature and higher pressure. Most preferably, at least one chain transfer agent is present in the polymerisation reaction at initiation. Suitable chain transfer agents are well known in the art. Typically they have at least one weak chemical bond, which facilitates the chain transfer reaction. Common chain transfer agents include thiols and halocarbons, such as carbon tetrachloride. In the present invention it has been found that thiols, particularly alkanethiols, such as mercaptan (methanethiol) and most preferably 1-dodecanethiol, provide particularly good results.

The polymerisation may be performed at any suitable temperature. Typically, the polymerisation is performed at a temperature in the range 30 to 80° C. In some embodiments temperature may be varied, such as increased, during the polymerisation.

The polymerisation may be performed at any suitable pressure. Typically, the polymerisation is performed at a pressure in the range of 2 to 20 bars (200 to 2000 kPa), such as 6 to 12 bars (600 to 1200 kPa). (As used herein all pressures, unless otherwise indicated, are absolute pressures.)

The polymerisation process may produce a homopolymer, or, by addition of one or more monomers other than vinyl chloride, may produce a copolymer. Typical comonomers include, for example, alkyl acrylates and methacrylates, and acetates such as vinyl acetate.

The polymerisation is generally initiated, after loading the reactor with required solvent, vinyl chloride and other reactants, by the introduction of the mixture of initiators. The initiators may be used in conventional quantities-generally speaking from 0.01 to 1% by weight calculated on vinyl chloride.

Although it is generally preferred to add all of the initiator mixture at the start of the process, in some embodiments a portion of the initiator mixture may be added during the polymerisation.

The activity control agent, when used, is present in any suitable amount to provide the required inhibition. General speaking it is added during the polymerisation as required to control the exotherm/polymerisation temperature and keep the control of the reaction rate. In preferred embodiments the activity control agent is added continuously with the rate of addition adjusted as required to control the exotherm of the polymerisation.

The polymerisation is continued until the desired conversion of monomer is reached.

Optionally, to terminate the polymerisation an inhibitor (or in particular a further inhibitor or a further amount of an already present inhibitor) may be added. Any suitable inhibitor may be used. Examples of suitable initiators include, for example, bases, such as alkali metal hydroxides and amines (including diethylhydroxyamine), and also a-methylstyrene. A preferred inhibitor in the present invention is an alkali metal halide, and more preferably the same alkali metal halide is used as inhibitor and as an activity control agent. Most preferably potassium iodide is used. In general, however, since the objective of this step is to permanently stop polymerisation larger quantities are used in this step.

Optionally an antifoaming agent is added at the end of the polymerisation. Any unreacted monomer can be removed by depressurising the reactor, and then the polymer solids can be recovered. Typically the polymer solids are subjected to a stripping step followed by filtration and drying. The polymer can be dried by any suitable method, for example in a fluid bed dryer.

As already noted, the process of the first aspect of the present invention can provide a mixture of the diacyl peroxide and the dialkyl peroxydicarbonate which does not comprise or only includes relatively small amounts of “mixed” products. Also, many “in-situ” initiator synthesis methods require the use of an anhydride precursor. This, however, leads to a carboxylic acid or carboxylate by-product. For example, reaction of isobutyric anhydride with hydrogen peroxide in the presence of a base to produce diisobutyryl peroxide results in formation also of two molecules of isobutyrate for each molecule of diisobutyryl peroxide formed. This increases the COD (“Chemical Oxygen Demand”) of the reaction mixture, which is disadvantageous.

The present invention can avoid these issues, and in particular can provide a composition without or with lower amounts of undesirable by-products.

Thus, in a third aspect, the present invention provides a composition which comprises at least a first initiator and a second initiator, wherein
a. the first initiator is a diacyl peroxide, said acyl having 2-8 carbon atoms, and
b. the second initiator is a dialkyl peroxydicarbonate, said alkyl having 1-4 carbon atoms,
   characterised in that
the composition comprises either no acyl peroxycarbonate or comprises acyl peroxycarbonate in an amount which is less than 20% by weight relative to the total weight of the first and second initiators, and
the composition comprises either no carboxylic acid or carboxylate salts, or comprises carboxylic acid or carboxylate salts in an amount which is less than 20% by weight relative to the total weight of the first and second initiators.

The preferred features of this composition, and in particular for the first and second initiator, are as already described for the first and/or second aspect. For example, preferably the weight ratio of the diacyl peroxide and the dialkyl peroxydicarbonate is from 1:4 to 4:1, more preferably from 1:3 to 3:1, such as 1:3 to 2:1, and most preferably from 1:3 to 1:1.

In a most preferred composition according to this third aspect, the diacyl peroxide is diisobutyryl peroxide and the dialkyl peroxydicarbonate is diethyl peroxydicarbonate.

In relation to acyl peroxycarbonate, the composition comprises either no acyl peroxycarbonate or comprises acyl peroxycarbonate in an amount which is less than 20% by weight relative to the total weight of the first and second initiators (the diacyl peroxide and dialkyl peroxydicarbonate) present. More preferably the composition comprises either no acyl peroxycarbonate or comprises acyl peroxycarbonate in an amount which is less than 10% by weight, such as less than 5% by weight, relative to the total weight of the first and second initiators.

In relation to carboxylic acid or carboxylate salts, the composition comprises either no carboxylic acid or carboxylate salts or comprises carboxylic acid or carboxylate salts in an amount which is less than 20% by weight relative to the total weight of the first and second initiators (the diacyl peroxide and dialkyl peroxydicarbonate) present. More preferably the composition comprises either no carboxylic acid or carboxylate salts or comprises carboxylic acid or carboxylate salts in an amount which is less than 10% by weight, such as less than 5% by weight, relative to the total weight of the first and second initiators.

It is noted that the presence of a carboxylic acid or carboxylate by-product is generally a result of “in-situ” initiator synthesis methods which use an anhydride precursor. Since the process of the first aspect of the present invention does not involve, or at least there is no need to involve, an anhydride precursor, typically a carboxylic acid or carboxylate by-product is not present in the initiator mixture obtained and used in the first aspect, and correspondingly in the preferred embodiments of the second aspect. For avoidance of doubt, however, it is also a generally preferred feature of the processes of the first and second aspects that either no carboxylic acid or carboxylate salts are present in the initiator mixture or the process, or that when they are present, any carboxylic acid or carboxylate salts are present in an amount which is less than 20% by weight relative to the total weight of the first and second initiators (the diacyl peroxide and dialkyl peroxydicarbonate) present. More preferably the composition comprises either no carboxylic acid or carboxylate salts or comprises carboxylic acid or carboxylate salts in an amount which is less than 10% by weight, such as less than 5% by weight, relative to the total weight of the first and second initiators.

More generally, in all aspects of the present invention it is preferred that any initiators other than the first and second initiators are present (in the composition or process) in an amount which is less than 20wt %, preferably less than 10wt % and more preferably less than 5wt % relative to the total weight of the first and second initiators present.

### EXAMPLES

### Synthesis of initiators

### Initiator 1

The synthesis was performed in a stirred autoclave reactor of volume 50 litres at atmospheric pressure and cooled to below 7° C.

In a first step, to the reactor there was added 23.1 kg of water, 6.9 kg of sodium chloride, 942 g of sodium hydroxide solution (concentration 220 g/kg), 185 g of hydrogen peroxide solution (concentration 350 g/kg) and 2.6 kg of dioctyl adipate (DOA)(purity 1000 g/kg). To this mixture was added 494 g of isobutyryl chloride (purity 970 g/kg). An exothermic reaction occurred to produce a solution of diisobutyryl peroxide. The isobutyryl chloride was added at a rate such as to ensure that the temperature did not exceed 7° C.

In a second step, to the same reactor still cooled below 7° C., and to the solution obtained from the first step, there was added a further 432 g of hydrogen peroxide solution (concentration 350 g/kg) and 1.1 kg of ethyl chloroformate (purity 970 g/kg). To this was then added a further 1.8 kg of sodium hydroxide solution (concentration 220 g/kg). An exothermic reaction occurred to produce diethyl peroxydicarbonate, and in particular a mixture of diisobutyryl peroxide and diethyl peroxydicarbonate. The sodium hydroxide was added at a rate such as to ensure that the temperature did not exceed 7° C.

The solution was allowed to separate into aqueous and organic (dioctyl adipate) phases, and the organic phase was separated. This solution comprises the diisobutyryl peroxide and diethyl peroxydicarbonate and in particular at a weight ratio of approximately 30/70 diisobutyryl peroxide/diethyl peroxydicarbonate in solution in dioctyl adipate, and at a concentration of the initiators of 282 g/kg of solution. The total yield of the two initiators was 86%.

3.2 kg of the solution obtained was used for the subsequent polymerisation (discussed below).

### Initiator 2

The synthesis of initiator 2 was performed in a similar manner to that of Initiator 1 except that no sodium chloride was added, and the quantities reacted were changed as follows:
First step:
10.3 kg of water,
942g of sodium hydroxide solution (concentration 220 g/kg),
168 g of hydrogen peroxide solution (concentration 350 g/kg)
2.4 kg of dioctyl adipate (DOA)(purity 1000 g/kg).
432 g of isobutyryl chloride (purity 970 g/kg).
Second step:
392g of hydrogen peroxide solution (concentration 350 g/kg),
975 g of ethyl chloroformate (purity 970 g/kg).
1.6 kg of sodium hydroxide solution (concentration 220 g/kg).

Further, no separation into aqueous and organic (dioctyl adipate) phases was performed. The solution obtained comprised a weight ratio of approximately 30/70 diisobutyryl peroxide/diethyl peroxydicarbonate, as for Initiator 1, but in this Example all of the resultant solution, including both the organic and aqueous phases, was used for the subsequent polymerisation (discussed below).

### Comparative Initiator 1

Comparative Initiator 1 comprised only diethyl peroxydicarbonate. This was synthesized in a conventional manner, and in a similar manner to the second step of the preparations described above, by firstly mixing ethyl chloroformate and hydrogen peroxide in a solution comprising water and dioctyl adipate, and then adding sodium hydroxide to cause the reaction.

Reaction was again performed in a stirred autoclave reactor of volume 50 litres at atmospheric pressure and cooled to below 7° C., and by addition of sodium hydroxide at a rate such as to ensure that the temperature did not exceed 7° C.

The solution obtained comprised diethyl peroxydicarbonate and both organic and aqueous phases, and was used in this form (i.e. without separation of the phases) for the subsequent polymerisation (discussed below).

### Polymerisation Reactions

### Example A

In a polymerization reactor with a capacity of 3800 L and equipped with a stirrer were added 794 kg of water, 18,850 kg of a solution of polyvinyl alcohol with a hydrolysis degree of 72.5% at 30 g/kg in water, 14,437 kg of a solution of polyvinyl alcohol with a hydrolysis degree of 88% at 30 g/kg in water and the solution of initiator 1.

Once the reactor was closed and agitation speed set up at 37 rpm, a vacuum was applied. Afterwards the agitation speed is set up at 120 rpm and 1203 kg of vinyl chloride were loaded. Once the vinyl chloride is added, 553 kg of water at 180° C. were loaded and the reaction mixture is heated to 57° C. with the double jacket.

1h00 after the polymerization temperature has reached 57° C., 4,8 kg of a solution of polyvinyl alcohol with a hydrolysis degree of 72.5% at 30 g/kg in water, 16 kg of a solution of polyvinyl alcohol with a hydrolysis degree of 88% at 30 g/kg in water were loaded in the polymerization reactor. The pipe was washed with 75 kg of water and loaded into the polymerization reactor.

From 1h30 to 03h30 after the polymerization temperature has reached 57° C., 397 kg of water were loaded into the polymerization reactor.

As required, potassium iodide activity control agent was added into the polymerization reactor in order to decrease the polymerization kinetics and to control the polymerization temperature once the maximal cooling capacity is reached with the double jacket.

Once the pressure drop took place 3 kg of a solution of inhibitor at 245 g/kg were introduced to stop the polymerization reaction, and the product was recovered.

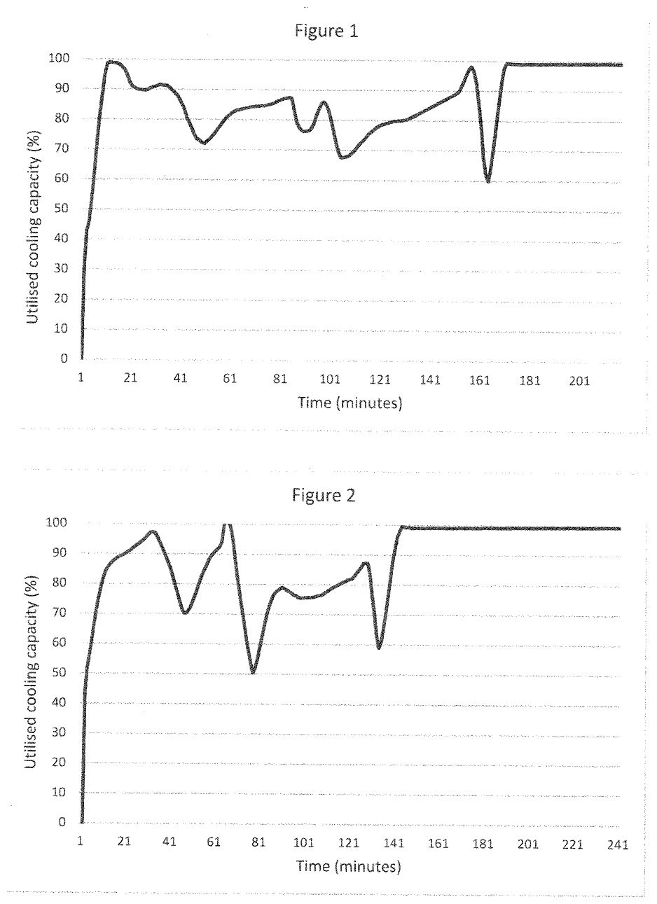

The reaction was stopped after approximately 3 hrs 40 minutes. FIG. 1 shows the percentage of the available cooling capacity used versus time during this time.

### Example B

Example A was repeated but using the solution comprising initiator 2.

In this case the reaction was stopped (once the pressure drop took place) after approximately 4 hrs, and FIG. 2 shows the percentage of the available cooling capacity used versus time during this time.

### Comparative Example A

Example A was repeated but using the solution comprising Comparative Initiator 1.

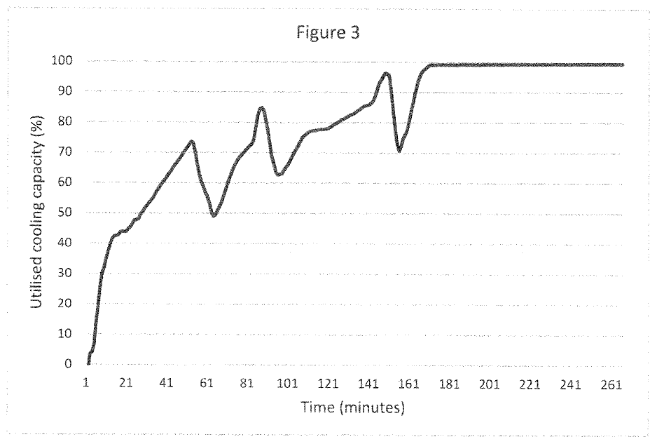

In this case the reaction took approximately 4 hrs 20 minutes. FIG. 3 shows the percentage of the available cooling capacity used versus time during this time.

### SUMMARY OF RESULTS

Comparison of Examples A and B with Comparative Example A shows improved use of the available cooling capacity. In particular, it can be seen that particularly during the initial stages of the process the reactor cooling capacity is better utilised. A consequence of this is a higher polymerisation rate and a shorter polymerisation process time.

1. A process for the production of PVC by polymerisation of vinyl chloride which comprises
a. reacting an acyl halide with a peroxide in a reactor to form a diacyl peroxide,
b. in the same reactor, and without removing the diacyl peroxide formed in step (a), reacting an alkyl haloformate with a peroxide, to form a dialkyl peroxydicarbonate, and to produce a mixture comprising the diacyl peroxide and the dialkyl peroxydicarbonate, and
c. using the mixture comprising the diacyl peroxide and the dialkyl peroxydicarbonate as an initiator mixture for the polymerisation of vinyl chloride.

2. The process according to claim 1 wherein the mixture comprising the diacyl peroxide and the dialkyl peroxydicarbonate is used as an initiator mixture for the polymerisation of vinyl chloride in a presence of an activity control agent.

3. The process according to claim 1 wherein the diacyl peroxide is a diacyl peroxide having an acyl with 2 to 8 carbon atoms.

4. The process according to claim 1 wherein the dialkyl peroxydicarbonate is a dialkyl peroxydicarbonate having an alkyl with 1-4 carbon atoms.

5. The process according to claim 1 wherein the mixture produced after reaction of the alkyl haloformate with the peroxide to form the dialkyl peroxydicarbonate in step (b) is used for the polymerisation of vinyl chloride in step (c) without purification and within 24 hours of a start of step (a) of the process.

6. The process according to claim 1 wherein the mixture produced after reaction of the alkyl haloformate with the peroxide to form the dialkyl peroxydicarbonate in step (b) comprises an aqueous phase and an organic phase, and the organic phase is separated from the aqueous phase to provide the mixture comprising the diacyl peroxide and the dialkyl peroxydicarbonate for use in step (c).

7. The process according to claim 6 wherein the mixture comprising the diacyl peroxide and the dialkyl peroxydicarbonate is stored for 24 or more hours before use in step (c).

8. A process for the production of PVC which comprises polymerising vinyl chloride in suspension in an aqueous medium using a mixture of initiators and using an activity control agent, where the activity control agent comprises an alkali metal halide, nitrogen monoxide or an alkali metal nitrite, and where the mixture of initiators comprises
a. a first initiator, which is a diacyl peroxide, said acyl having 2-8 carbon atoms, and
a second initiator, which is a dialkyl peroxydicarbonate, said alkyl having 1-4 carbon atoms.

9. The process according to claim 8 wherein the mixture of initiators in the process is obtained by adding a mixture comprising the first and second initiators to the process.

10. The process according to claim 9 wherein the mixture comprising the initiators is added to the process at a start of the polymerisation.

11. The process according to claim 8 wherein the activity control agent is an alkali metal halide.

12. The process according to any one of the claim 1 wherein the diacyl peroxide is diisobutyryl peroxide and the dialkyl peroxydicarbonate is diethyl peroxydicarbonate.

13. A composition which comprises at least a first initiator and a second initiator, wherein
a. the first initiator is a diacyl peroxide, said acyl having 2-8 carbon atoms, and
b. the second initiator is a dialkyl peroxydicarbonate, said alkyl having 1-4 carbon atoms,
wherein
the composition comprises either no acyl peroxycarbonate or comprises acyl peroxycarbonate in an amount which is less than 20% by weight relative to total weight of the first and second initiators, and
the composition comprises either no carboxylic acid or carboxylate salts, or comprises carboxylic acid or carboxylate salts in an amount which is less than 20% by weight relative to the total weight of the first and second initiators.

14. The composition according to claim 13 wherein the diacyl peroxide is diisobutyryl peroxide and the dialkyl peroxydicarbonate is diethyl peroxydicarbonate.

15. The composition according to claim 13 wherein the mixture comprises the diacyl peroxide and the dialkyl peroxydicarbonate at a molar ratio of 1:3 to 1:1.

16. The process according to claim 8 wherein the activity control agent is potassium iodide.

17. The process according to claim 8 wherein the diacyl peroxide is diisobutyryl peroxide and the dialkyl peroxydicarbonate is diethyl peroxydicarbonate.
